(19) United States
(12) Patent Application Publication
(10) Pub. No.: US 2024/0368033 A1
(43) Pub. Date: Nov. 7, 2024

(54) THIXOTROPY AND RHEOLOGY MODIFYING ADMIXTURE FOR CEMENT-BASED MORTARS AND PRODUCTION OF CEMENT-BASED COMPOSITIONS INCLUDING THE ADMIXTURE

(71) Applicant: OZYEGIN UNIVERSITESI, Istanbul (TR)

(72) Inventors: Zeynep BASARAN BUNDUR, Istanbul (TR); Eylul Mina AYDIN, Istanbul (TR)

(73) Assignee: OZYEGIN UNIVERSITESI, Istanbul (TR)

(21) Appl. No.: 18/714,762

(22) PCT Filed: Jan. 25, 2022
(86) PCT No.: PCT/TR2022/050057

§ 371 Date: May 30, 2024

(30) Foreign Application Priority Data
Dec. 29, 2021 (TR) 2021/021518

(51) Int. Cl. C04B 7/12; B28B 1/00; B33Y 10/00; B33Y 70/00; C04B 7/26; C04B 14/06; C04B 22/04; C04B 40/00; C04B 103/00; C04B 103/30; C04B 103/32

(52) U.S. Cl. CPC C04B 7/12; B28B 1/001; B33Y 10/00; B33Y 70/00; C04B 7/26; C04B 14/06; C04B 22/04; C04B 40/0046; C04B 2103/0001; C04B 2103/32; C04B 2103/34

(57) ABSTRACT

An admixture suitable for use in cement-based mortars to provide improved thixotropic and rheological properties and a method for the production of cement mortar materials in which the said admixtures are included as components and the use of the said cement mortar materials with improved thixotropic and rheological properties are provided. The cement-based composition is printed as the building material by means of the 3-Dimensional printer.

### CROSS REFERENCE TO THE RELATED APPLICATIONS

This application is the national phase entry of International Application No. PCT/TR2022/050057, filed on Jan. 25, 2022, which is based upon and claims priority to Turkish Patent Application No. 2021/021518, filed on Dec. 29, 2021, the entire contents of which are incorporated herein by reference.

### TECHNICAL FIELD

The invention relates to an admixture suitable for use in cement-based compositions to provide improved thixotropic and rheological properties and a method for the production of cement-based compositions in which the said admixtures are included as components and the use of the said cement-based compositions with improved thixotropic and rheological properties.

### BACKGROUND

Fresh properties of concrete can directly affect the hardening process and the hardened properties gained afterwards. The irreversibility of the hardening of the concrete requires the establishment of the quality control and assurance system starting from the supply of the components before the hardening process. The fresh properties of the concrete can be inspected, and the desired hardened concrete properties can be controlled since they depend on its components and mixing process. In a good concrete, all fine aggregate particles should be covered with cement paste and all coarse aggregate particles should be completely covered with mortar. The three main properties expected from concrete in the most general sense are workability, strength and durability. Among these properties, strength and durability are valid for hardened concrete and workability is valid for fresh concrete.

Rheology has a high importance in examining the flow characteristics of the substances used in the production phase of fresh mortar and concrete and mixing the substances. It is known that fresh mortar and concrete can exhibit the Herschel and Bulkley viscoplastic model according to equation (1). Here τ (Pa) defines the shear stress at the shear rate of γ (1/s), while τ0 (Pa) and μ (Pa·s) define the shear threshold and plastic viscosity.

$$τ = {τ}_{o} + K {\dot{γ}}^{n} . \qquad Equation 1$$

Water-soluble polymers are generally used as rheology modifying admixtures in cement-based materials in the relevant technical field. These polymers can be composed of cellulose, acrylic or polyethylene for cement-based materials. The use of biomaterials such as polysaccharides and bioplastics as rheology modifying admixtures for the production of low-cost, sustainable and environmentally friendly cements and mortars is increasing day by day.

There are studies in the relevant technical field using biomaterials or microbial polysaccharide components for cement-based compositions. The invention with patent number WO2019054969, which is one of the said studies, relates to sand and fiber containing structure, architectural, industrial materials obtained by the bacterial biocalcification method and products obtained by this method. Bacterial cells are used as binders in this invention. In this context, bacterial species such as Sporosarcina pasteurii, Bacillus arenosi, Sporosarcina urea, Brevibacterium ammoniagenes, Bacillus sp. are used.

The invention with patent number WO2017119859 A1 provides rheologically improved cement-based compositions with the use of disease-free bacteria that can be easily obtained from nature. The cement-based compositions according to the present invention include Sporosarcina pasteurii, Bacillus mageterium, Bacillus subtilis and Paenibacillus polymyxa strains, known as active swimmers in solutions.

The invention with patent number KR101620074 relates to obtaining an environmentally friendly concrete with strength, toughness and other durability values suitable for use in a 3D printer as well as meeting quality specifications. The invention uses mixtures of blast furnace slag and cement 93L components as binding materials. Bacillus flexus, Bacillus flexus, Bacillus Firmus, Bacillus Firmus, Brevibacillus agri, Bacillus circulans, Lactobacillus farraginis, Bacillus Firmus, Bacillus flexus, Bacillus flexus, Bacillus, etc. are the most preferred microorganisms as microorganisms.

Studies in the relevant technical field have proven that biomaterials and microbial strains for the improvement of rheological and thixotropic properties for cement-based compositions can be used as admixtures. It is the subject of studies that the thixotropic and rheological properties of cement-based compositions should be improved. New technical solutions should be obtained to provide improved rheological and thixotropic properties at desired levels for cement-based compositions containing biomaterials and microbial strains and innovations in this technical field as gaining importance.

### SUMMARY

The present invention relates to a rheology and thixotrophy modifying admixture suitable for use in cement mortars in order to eliminate the disadvantages for the related technical field and to provide additional technical solutions and advantages to the related technical field.

In one aspect, the invention aims to obtain a cement-based mortar with improved thixotropic and rheological properties due to the use of admixture.

In one aspect, the invention relates to the production of cement-based mortar as a building material with improved thixotropic and rheological properties due to the use of admixture.

The invention is a cement-based composition for providing all these benefits, comprising at least one selected from the group of Sporosarcina pasteurii, Bacillus megaterium, Bacillus subtilis and Paenibacillus polymyxa strains for improving thixotropic and rheological properties and at least one of sepiolite and/or bentonite clay species as admixture.

The possible embodiment of the invention is a cement-based composition with improved thixotropic and rheological properties in which the bacterial strain is at least one of Sporosarcina pasteurii and/or Bacillus megaterium.

The possible embodiment of the invention is a cement-based composition with improved thixotropic and rheological properties in which the admixture is sepiolite.

The possible embodiment of the invention is a cement-based composition with improved thixotropic and rheological properties in which the strain of the bacterium is in the range of 0.5 to 1.5% by weight.

The possible embodiment of the invention is a cement-based composition with improved thixotropic and rheological properties in which the admixture is in the range of 0.2% to 1% by weight.

The possible embodiment of the invention is a cement-based composition with improved thixotropic and rheological properties in which the admixture is in the range of 0.5% to 1.5% by weight.

The possible embodiment of the invention is that it comprises one of the values of 0.6%, 0.7%, 0.8%, 0.9% or 1% by weight of the admixture in the cement-based composition.

The possible embodiment of the invention is that it contains at least one selected from the group of Sporosarcina pasteurii, Bacillus megaterium, Bacillus subtilis and Paenibacillus polymyxa strains and at least one of sepiolite and/or bentonite clay species as admixture, as well as cement, fly ash as binder and water as component.

The possible embodiment of the invention is a cement-based composition with improved thixotropic and rheological properties in which the amount of binder: water is in the range of 0.36 to 0.4 by weight.

The possible embodiment of the invention is a cement-based composition with improved thixotropic and rheological properties containing sand.

The possible embodiment of the invention is a cement-based composition with improved thixotropic and rheological properties in which the amount of sand: binder is in the range of 1:1 to 1.5:1 by weight.

The possible embodiment of the invention is a cement-based composition with improved thixotropic and rheological properties comprising at least one of superplasticizer and aluminum powders to contribute to the flowability.

The invention also relates to the production of said cement-based composition. Accordingly, the said production method includes the following process steps.
obtaining cement-based composition comprising admixtures and at least one selected from the group of Sporosarcina pasteurii, Bacillus megaterium, Bacillus subtilis and Paenibacillus polymyxa strains to improve thixotropic and rheological properties,
printing the resulting cement-based composition as a building material by means of a 3-Dimensional printer.

In the possible embodiment of the invention, the production of the cement-based composition comprises the following processes.
i. Separating the bacterial strains containing at least one selected from the group of Sporosarcina pasteurii, Bacillus megaterium, Bacillus subtilis and Paenibacillus polymyxa strains from media by centrifugation and keeping them in water,
ii. Preparing the cement-based composition and carrying out the mixing process, then adding the sand component and remixing,
iii. Performing the process of dissolving rheology and thixotrophy modifying admixtures in water and performing the mixing process,
iv. Adding the mixture water obtained in the process step iii) to the mixture obtained in the process step ii) and performing the mixing process,
   wherein the said binder: water ratio is in the range of 0.36 to 0.4 by weight,
V. Adding the water-bacteria strain mixture obtained in the process step i) to the mixture obtained in the process step iv) and performing the mixing process,
vi. Obtaining building materials by printing the mixture obtained in the process step in v) by means of 3-Dimensional printers.

The possible embodiment of the invention is that the bacterial strain is in the range of 0.5% to 1.5% by weight in the cement-based composition.

The possible embodiment of the invention is that the amount of addition of the sand component is in the range of 1:1 to 1.5:1 by weight of sand: binder in the cement-based composition.

The possible embodiment of the invention is that the admixture is in the range of 0.1 to 2% by weight in the cement-based composition.

The possible embodiment of the invention is that it is in the range of 0.5 to 1% by weight in the cement-based composition.

The possible embodiment of the invention is that the mixing process is performed for at least 1 minute in the process step iii).

The possible embodiment of the invention is that the number of layers in the process step vi) is between 15-20.

The possible embodiment of the invention is that the extruder width in process step vi) is in the range of 20 to 24 mm.

The possible embodiment of the invention is that the flow rate in the process step vi) is in the range of 1.8-4 mL/s.

The possible embodiment of the invention is that the layer thickness in the process step vi) is in the range of 15 to 20 mm.

The possible embodiment of the invention is that the speed of the printer in the process step vi) is in the range of 6 to 10 mm/s.

### DETAILED DESCRIPTION OF THE EMBODIMENTS

In this detailed description, the subject of the invention relates to an admixture that can be used for cement-based mortars to provide improved thixotropic and rheological properties and is explained with examples that do not have any limiting effect only for a better understanding of the subject.

Clay-based components are used as admixtures. The said clay material is preferably at least one or both sepiolite and/or bentonite components.

The admixture is preferably sepiolite.

The admixture is preferably bentonite.

The admixture is preferably a mixture of bentonite and sepiolite components.

In another aspect, the invention relates to cement-based compositions having improved rheological and thixotropic properties. As mentioned in the invention, the cement-based composition refers to finely ground and calcined calcium silicates and calcium alumina that react with hydraulic cement, that is, water, to form hard, rock-like masses. Preferably, Portland cement, pozzolan cement, blast furnace slag cement, slag cement, mortar cement, construction concrete, air bubble cement, lightweight concrete, heavy concrete and low temperature cement, one of the ceramics or mixtures thereof are used as cement binders in cement-based compositions.

The main function of the admixture of the invention is to improve the rheological and thixotropic properties of cement-based compositions. The admixture of the invention contributes to the rheological values of the cement-based composition materials by interacting with the water and other components in the cement-based composition and with the electrostatic and Van der Waals or other types of interaction. Accordingly, the cement-based composition is in the range of 0.1% to 2% by weight as admixture: binder. Preferably this value is in the range of 0.5% to 1.5% by weight as admixture: binder. The admixture is preferably one of the values of 0.6%, 0.7%, 0.8%, 0.9% or 1% by weight of the admixture: binder in the cement-based composition.

In another aspect, the invention relates to cement-based compositions having improved rheological and thixotropic properties. As mentioned in the invention, the cement-based composition refers to finely ground and calcined calcium silicates and calcium alumina that react with hydraulic cement, that is, water, to form hard, rock-like masses. Preferably, Portland cement, pozzolan cement, blast furnace slag cement, slag cement, mortar cement, construction concrete, air bubble cement, lightweight concrete, heavy concrete and low temperature cement, one of the ceramics or mixtures thereof are used as cement binders in cement-based compositions.

The cement-based composition of the invention contains one or more of the cements given as binder, as well as water.

The cement-based composition of the invention contains cement and mixtures thereof as a binder, as well as fly ash. The said binder is in the cement-based composition in the range of 0.36 and 0.4 by weight as water: binder.

The cement-based composition of the invention contains one or mixtures of the cements as binder, as well as sand. The said sand component is in the range of 1:1 and 1.5:1 by weight as sand: binder in the cement-based composition.

The said cement-based compositions comprise at least one selected from the group of Sporosarcina pasteurii, Bacillus megaterium, Bacillus subtilis and Paenibacillus polymyxa strains as rheological modifiers. The preferred strain is one of Sporosarcina pasteurii and/or Bacillus megaterium strains.

Preferably, the cement-based composition comprising the bacterial strain as rheology and thixotropic improving component is in the range of 0.3% to 1% by weight.

The cement-based composition of the invention contains at least one of bentonite and/or sepiolite clays as admixture; as well as at least one selected from the group of strains of Sporosarcina pasteurii, Bacillus megaterium, Bacillus subtilis and Paenibacillus polymyxa as rheological modifier.

The cement-based composition of the invention contains one of the mentioned strains and at least one of the clay admixtures and expects a synergistic effect to occur between them. It provides a cement-based composition with improved rheological and thixotropic properties from the cement-based compositions in the present art due to the said synergistic effect.

The cement-based composition of the invention contains additional binding components. It contains at least one of pozzolan and/or silica fume as said additional binding components.

The cement-based composition of the invention may comprise at least one of the superplasticizer and hydration admixture components to contribute to flowability.

The cement-based composition of the invention is preferably obtained in the form of 3-Dimensional printers. It is not possible to obtain raw materials that can be used for 3-Dimensional printers with only bacterial strains included as components as rheological and thixotropic modifiers. The inventors have determined that in order to be used as a raw material in 3-Dimensional printers, it must have a low dynamic yield stress and a high static yield stress. An extrudable and constructable cement-based composition can be obtained in this way. The cement-based composition of the invention contains admixture and bacterial strains as rheological and thixotropic modifiers. The presence of these components provides a low dynamic yield stress and a high static yield stress for the cement composition. In addition, the admixture subject to the invention provides stability by creating a synergistic effect with bacterial strains for the cement-based composition. A cement-based composition suitable for being produced as building materials in 3-Dimensional printers can be obtained in this way.

The invention provides a method for the production of the cement-based composition, which is characterized to provide all the aforementioned benefits. The said production method includes the following process steps;
i. Separating bacterial strains from the media by centrifugation and keeping them at 4° C. until use and then washing them with sterilized PBS or DI water,
ii. Dissolving the bacterial strains and admixtures obtained in the process I) in water and obtaining the mixture water by mixing,
iii. Obtaining the binder by mixing the binder components (cement, fly ash, slag, etc.) together,
iv. Adding the mixture water obtained in the process step ii) to the mixture obtained in the process step iii) and performing the mixing process,
   wherein the said binder: total water ratio is in the range of 0.36 to 0.4 by weight,
V. Adding sand to the mixture with a binder: sand ratio of 1:1 or 1:1.5, with a maximum particle size of 1 mm,
vi. Obtaining building materials by printing the mixture obtained in the process step v) in 3-Dimensional printers.

In the process step i), it contains at least one selected from the group of strains of Sporosarcina pasteurii, Bacillus megaterium, Bacillus subtilis and Paenibacillus polymyxa as the bacterial strain.

In the process step i), the said centrifugation process is carried out in such a way that the bacterial strain amount is between 6000 g and 6500 g. Preferably, the centrifugation process time is at least 10 minutes.

The bacterial strain mentioned in step i) is in the range of 0.3% to 1% by weight in the cement-based composition.

The admixture mentioned in step iii) is at least one of the sepiolite and/or bentonite clays,

In the process step iii), the admixture is preferably in the range of 0.2 to 1% by weight in the cement-based composition. The admixture is preferably in the range of 0.5 to 1.5% by weight in the cement-based composition.

The mixing process mentioned in the process step iii) is carried out for at least 3 minutes.

The amount of addition of the sand component mentioned in step v) is in the range of 1:1 to 1.5:1 by weight as sand: binder in the cement-based composition.

| Parameters | Unit | Value |
|---|---|---|
| Layer Count | — | 15-20 |
| Extruder Width | mm | 20-24 |
| Flow rate | mL/s | 1.8-4 |
| Layer thickness | mm | 15-20 |
| Printer Speed | mm/s | 6-10 |

The cement-based composition containing the rheological and thixotropic admixture components and bacterial strains of the invention can be used as injection mortar.

The cement-based composition containing the rheological and thixotropic admixture components and bacterial strains of the invention can be used as a raw material in the construction industry.

The cement-based composition containing rheological and thixotropic admixture components and bacterial strains of the invention can be used in tunnel molding applications, water tanks, roads, bridges, high buildings, concrete briquettes, building chemicals, coastal-port constructions, concrete and reinforced concrete underground water pipes, treatment facilities, dam constructions, plaster and wall mortar.

The cement mortar described with the information given in the invention contains admixtures and bacterial strains that allow the improvement of rheological and thixotropic properties. Thus, a cement-based composition with a low dynamic yield stress and a high static yield stress can be obtained in order to obtain the mortars that can be used to obtain the building materials in 3-Dimensional printers.

The scope of protection of the invention is specified in the attached claims and cannot be limited to those explained for sampling purposes in this detailed description. It is evident that a person skilled in the art may exhibit similar embodiments in light of above-mentioned facts without drifting apart from the main theme of the invention.

What is claimed is:

1. A cement-based composition, comprising a bacterial strain for improving thixotropic and rheological properties and a clay species as an admixture, wherein the bacterial strain is at least one selected from the group consisting of Sporosarcina pasteurii, Bacillus megaterium, Bacillus subtilis, and Paenibacillus polymyxa, and the clay species is at least one of sepiolite and bentonite.

2. The cement-based composition according to claim 1, wherein the bacterial strain is at least one of the Sporosarcina pasteurii and the Bacillus megaterium.

3. The cement-based composition according claim 1, wherein the admixture is the sepiolite.

4. The cement-based composition according to claim 1, wherein the bacterial strain is in a range of 0.5% to 1.5% by weight.

5. The cement-based composition according to claim 1, wherein the admixture is in a range of 0.2% to 1% by weight.

6. The cement-based composition according to claim 1, wherein the admixture is in a range of 0.5% to 1.5% by weight.

7. The cement-based composition according to claim 1, wherein the admixture is comprised at a value of 0.6%, 0.7%, 0.8%, 0.9%, or 1% by weight.

8. The cement-based composition according to claim 1, further comprising cement, fly ash as a binder, and water as a component.

9. The cement-based composition according to claim 8, wherein an amount of the binder: the water is in a range of 0.36 to 0.4 by weight.

10. The cement-based composition according to claim 8, further comprising sand.

11. The cement-based composition according to claim 10, wherein an amount of the sand: the binder is in a range of 1:1 to 1.5:1 by weight.

12. The cement-based composition according to claim 1, further comprising at least one of a superplasticizer and an aluminum powder to contribute to a flowability.

13. A method for producing the cement-based composition according to claim 1, comprising process steps of
obtaining the cement-based composition comprising the admixture and the bacterial strain to improve the thixotropic and rheological properties,
printing the cement-based composition as a building material by a 3-Dimensional printer.

14. The method according to claim 13, comprising the following process steps;
i. separating the bacterial strains comprising at least one selected from the group consisting of the Sporosarcina pasteurii the Bacillus megaterium, the Bacillus subtilis, and the Paenibacillus polymyxa from media by a centrifugation and keeping a separated bacterial strain in a first water to obtain a water-bacterial strain mixture,
ii. preparing the cement-based composition and carrying out a first mixing process on the cement-based composition to obtain a first mixture, then adding a sand component to the first mixture and remixing to obtain a second mixture,
iii. performing a process of dissolving rheology and thixotrophy modifying admixtures in a second water and performing a second mixing process to obtain a mixture water,
iv. adding the mixture water obtained in the process step iii) to the second mixture obtained in the process step ii) and performing a third mixing process to obtain a third mixture,
wherein a binder: water ratio is in a range of 0.36 to 0.4 by weight,
V. adding the water-bacterial strain mixture obtained in the process step i) to the third mixture obtained in the process step iv) and performing a fourth mixing process to obtain a fourth mixture,
vi. obtaining the building material by printing the fourth mixture obtained in the process step in v) in the 3-Dimensional printer.

15. The method according to claim 13, wherein the bacterial strain is in a range of 0.5% to 1.5% by weight in the cement-based composition.

16. The method according to claim 14, wherein an amount of an addition of the sand component is in a range of 1:1 to 1.5:1 by weight in the cement-based composition.

17. The method according to claim 13, wherein the admixture is in a range of 0.1% to 2% by weight in the cement-based composition.

18. The method according to claim 17, wherein the admixture is in the range of 0.5 to 1% by weight in the cement-based composition.

19. The method according to claim 14, wherein the second mixing process is carried out for at least 1 minute in the process step iii).

20. The method according to claim 14, wherein a number of layers of the building material in the process step vi) is between 15-20.

21. The method according to claim 14, wherein an extruder width in the process step vi) is in a range of 20 mm to 24 mm.

22. The method according to claim 14, wherein a flow rate of the 3-Dimensional printer in the process step vi) is in a range of 1.8-4 mL/s.

23. The method according to claim 14, wherein a layer thickness of the building material in the process step vi) is in a range of 15 mm to 20 mm.

24. The method according to claim 14, wherein a speed of the 3-Dimensional printer in the process step vi) is in a range of 6 mm/s to 10 mm/s.
